(19) United States
(12) Patent Application Publication
(10) Pub. No.: US 2009/0151242 A1
(43) Pub. Date: Jun. 18, 2009

(54) Collapsible plant shelter

(76) Inventors: Michael S. Kellogg, Oconomowoc, WI (US); Dean B. Krotts, Milwaukee, WI (US)

Correspondence Address: RYAN KROMHOLZ & MANION, S.C., POST OFFICE BOX 26618, MILWAUKEE, WI, 53226, US

(21) Appl. No.: 12/001,862

(22) Filed: Dec. 13, 2007

(51) Int. Cl. A01G 13/02

(52) U.S. Cl. 47/29.6

(57) ABSTRACT

An apparatus according to the present invention provides a collapsible plant shelter. A plurality of flexible panels is joined to form a supportive structure. Each panel is formed from a flexible material coupled, directly or indirectly, to a flexible frame member. At least a portion of the flexible material is preferably at least partially fluid impervious and not completely opaque, so as to provide a greenhouse effect to the interior of the shelter. A top flexible panel may also be provided, coupled to a top portion of at least two of the side panels. A selectively closeable access portal may be provided through one or more of the side panels. A portal flap may be at least partially releasable from the side panel material, such as by way of a zipper.

### BACKGROUND OF THE INVENTION

The present invention relates generally to the field of plant husbandry, and more particularly to a collapsible plant shelter.

Collapsible plant shelters have been desirable, and indeed employed, for some time. Generally, however, prior plant shelters may not provide sufficient collapsibility for some users. For instance, a prior plant shelter may be a coiled wire coupled to a flexible membrane. While the coiled wire longitudinally compresses a certain extent, the compression ratio of collapsed length to expanded length may not be small enough to accommodate storage. Also, some prior collapsible plant shelters utilize a combination of rigid support members and flexible membranes. These prior devices may offer suitable coverage and collapsibility; however, sacrifice is often made during storage. The rigid members of prior devices tend to be bulky or awkward, often limiting storage options.

Therefore, the art of plant husbandry would benefit from an improved collapsible plant shelter that addresses at least the stated storage concerns surrounding prior devices.

### SUMMARY OF THE INVENTION

The present invention provides an improved collapsible plant shelter that addresses at least the stated storage concerns surrounding prior devices. A collapsible plant shelter is provided that may include at least three side panels. Each side panel is comprised of a flexible panel material coupled to a frame member having a folded and an unfolded configuration. When a frame member is in its unfolded configuration, its associated flexible panel material assumes the configuration of its associated frame member. Each side panel has a top portion and a bottom portion, where the top portion may be narrower than the bottom portion. Each panel also has an inside surface and an outside surface, where each side panel is coupled to at least a first adjacent side panel and a second adjacent side panel. At least part of the flexible panel material is fluid impervious and may be substantially nonopaque, such as a clear, polyethylene sheet material.

In one embodiment, the flexible material of the panels is directly coupled to its associated frame member. Additional components may be provided, such as a stake loop coupled to the bottom portion of at least one of the panels and/or a reinforcement gusset coupled to the bottom portion of two adjacent side panels.

In another embodiment, a flexible top panel is coupled to the top portion of a plurality of the side panels. The flexible top panel may comprise a material that is the same as the side panel material or different material. In one embodiment, the top panel is a flexible mesh material.

In yet another embodiment, when the shelter is placed upon a desired support surface, an angle measured between the outside surface of the panel material and the support surface is obtuse. Thus, the top portions of the side panels may be biased towards each other.

In still another embodiment, at least one of the side panels includes a selectively closeable access portal. The access portal may be selectively closeable through the use of a portal flap hingedly coupled proximate the top portion of each of the side panels having the portal. The portal flap may be at least partially selectively releasable from the flexible panel material, such as by way of a zipper. In one embodiment, the portal flap may be held out of the way by a flap retainer coupled near the top portion of the side panel

A further embodiment includes a shelter comprising four of the side panels, wherein each of two of the side panels includes a selectively closeable access portal. The two side panels including the selectively closeable access portal may be located on diametrically opposed sides of the shelter.

A still further embodiment comprises only two collapsible side panels having a flexible frame member, each having a top portion and a bottom portion in its expanded state. The two side panels are generally arranged in a V configuration so that the top portion of a first panel is coupled, directly or indirectly, to the top portion of a second panel. Further, one or two side gusset panels may be coupled to the side panels. The gusset panel comprises a flexible gusset material and may also include a top vent that is preferably formed from a mesh material.

### BRIEF DESCRIPTION OF THE DRAWINGS

FIG. 1 is a perspective view of a first embodiment of a collapsible plant shelter according to the present invention.

FIG. 2 is a front elevation view of the embodiment of FIG. 1.

FIG. 3 is a top plan view of the embodiment of FIG. 1 in an unfolded configuration.

FIG. 4 is a perspective view of the embodiment of FIG. 1 in first folded configuration.

FIG. 5 is a perspective view of the embodiment of FIG. 1 in a second folded configuration.

FIG. 6 is a perspective view of the embodiment of FIG. 1 in a third folded configuration.

FIG. 7 is a perspective view of a second embodiment of a collapsible plant shelter according to the present invention.

FIG. 8 is a second perspective view of the embodiment of FIG. 7.

FIG. 9 is a perspective view of a third embodiment of a collapsible plant shelter according to the present invention.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

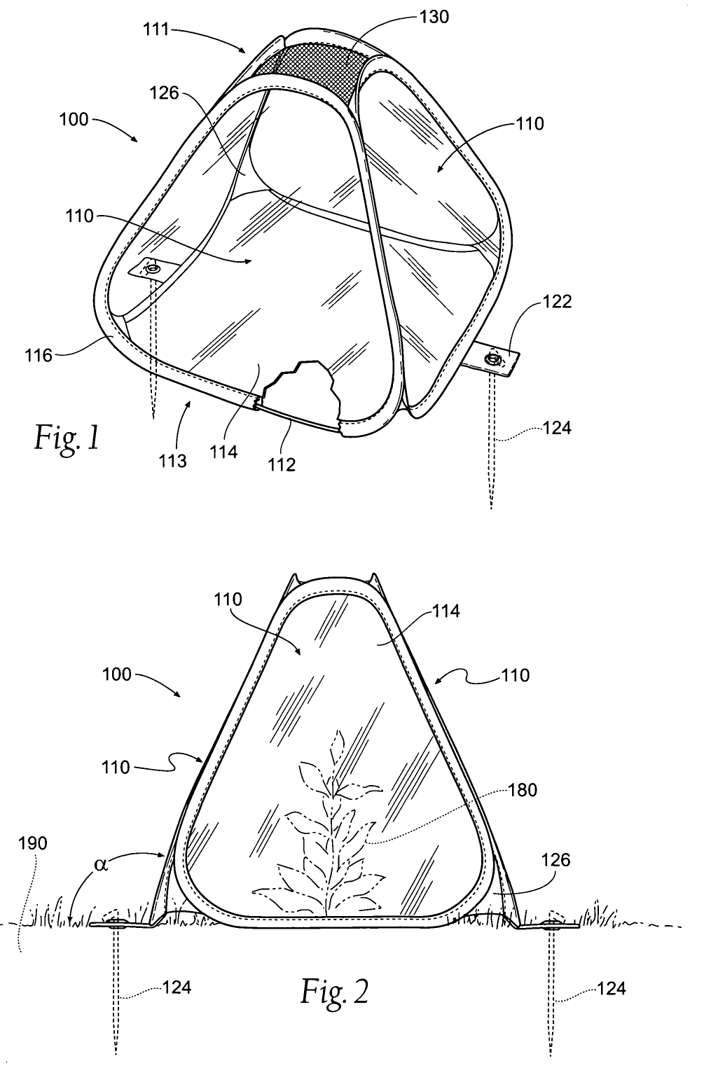

Turning now to the figures, FIG. 1 provides a first embodiment 100 of a collapsible plant shelter according to the present invention. Generally, the embodiment 100 comprises at least three, but preferably four, collapsible side panels 110. Each side panel 110 includes a flexible frame member 112, which has a folded and unfolded configuration, and a flexible panel material 114 coupled, directly or indirectly, to the frame member 112. Each side panel 110 in its unfolded configuration has a top portion 111 and a bottom portion 113, the top portion 111 being preferably narrower than the bottom portion 113. The flexible panel material 114 may be directly coupled to the frame member 112 by, for example, cutting the panel material 114 in a desired shape slightly larger than the frame member 112 and by folding the panel material 114 around the frame member 112 and securing it thereto, either by fastening the panel material 114 to itself by way of adhesive, sewing or the like, or by fastening the panel material 114 to the frame member 112 by way of adhesive, for example. The flexible panel material 114 may be indirectly coupled to the frame member 112 by way of other structures, such as a support pocket 116 formed from a pocket material, which may or may not be the same composition as the flexible panel material 114.

Other components may be provided as a part of, or fastened to, one or more of the side panels 110. For instance, stake loops 122 may be provided proximate the bottom portion 113 of one or more panels 110. Through the stake loops 122, a stake 124 may be inserted, thereby cooperating with the ground or other support surface to maintain the plant shelter 100 in a desired location. In addition to the stake loops 122, reinforcement gussets 126 may be added as a part of or fastened to a plurality of side panels 110. In addition to stake loops 122 and support gussets 126, a top panel 130 may be provided, coupled to at least one but preferably multiple side panels 110 proximate the top portion 111 thereof. The top panel 130 is formed from a top panel material that may be the same as or different than the side panel material 114. In this embodiment 100, the top panel 130 comprises a flexible mesh material.

While the flexible side panel material 114 may be any material suitable for providing desired plant coverage, at least a portion of the panel material 114 preferably comprises a nonopaque, flexible, fluid impervious material, such as a clear polyethylene sheet material. Use of such material may provide a desired greenhouse effect that may be advantageous to starting or maintaining plant growth. Alternatively, if it is desirable to only shade a plant, a fluid pervious material that provides desired shade could also be used. The side panels 110 are generally arranged in a ring configuration so that a given panel 110a is coupled, directly or indirectly, to two other panels 110b,110d.

As seen in FIG. 2, to use this first embodiment 100 of a collapsible plant shelter according to the present invention, the shelter 100 is simply placed, in its uncollapsed configuration, over a plant 180 and preferably staked to the ground 190 or supported by a different existing support structure. When placed on relatively level ground 190, the side panels 110 preferably intersect the supporting surface at an angle α. Though a variety of angles would suffice, such angle α is preferably obtuse.

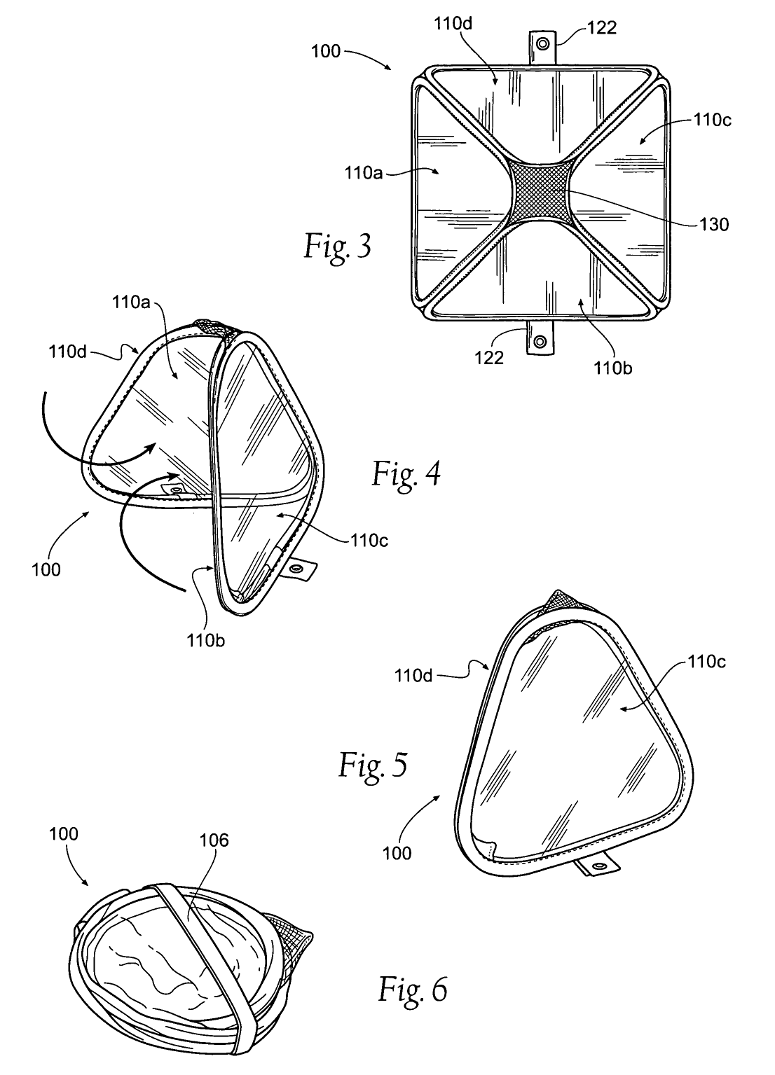

FIG. 3 provides a top plan view of the embodiment 100 of FIG. 1. Generally, the embodiment 100 includes four side panels 110a,110b,110c,110d. FIGS. 4-6 provide a preferred collapse sequence of the embodiment 100. FIG. 4 provides a depiction of a first folded configuration of the embodiment of FIG. 1. In FIG. 4, a corner formed by two adjacent side panels 110a,110b has been forced towards the opposing corner formed by the other two adjacent side panels 110c,110d. In the event that an embodiment is formed with an odd number of side panels 110, one intersection of two side panels may be selectively disengageable, thereby allowing a zig-zag fold of the panels. In a second folded configuration, shown in FIG. 5, the two adjacent side panels 110a,110b have been folded to lie against each other, thereby forming a generally flat collapsed plant shelter 100 which may be stored accordingly, if desired. If further collapsibility is warranted, the plant shelter 100 may be folded into a third folded configuration.

FIG. 6 illustrates a further collapse of the embodiment 100 of FIG. 1 into a third folded configuration. Along a side of the flat shelter shown in FIG. 5, a user may place thumbs on one panel 110c and fingers opposed on another panel 110d. A simple rotation of each wrist-toward the other causes the shelter 100 to coil into thirds. An elastic strap 106 may be provided to maintain the third folded configuration for storage.

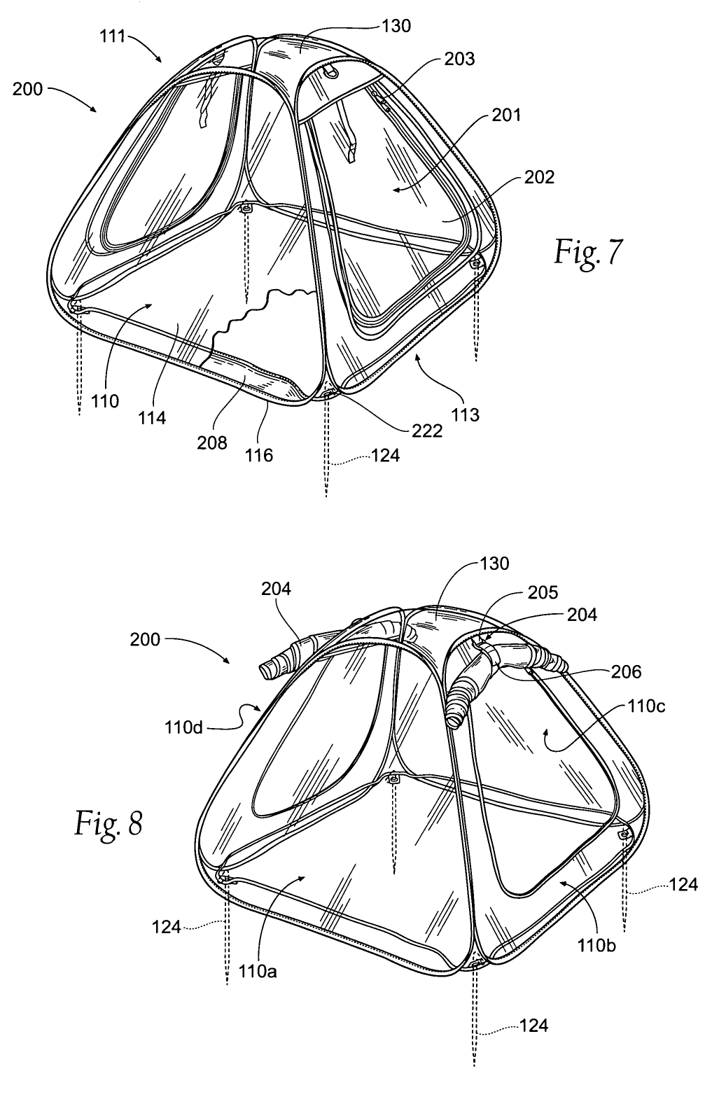

Turning now to FIG. 7 and FIG. 8, a second embodiment 200 of a plant shelter according to the present invention is shown. Like the first embodiment 100, this embodiment 200 comprises at least three, but preferably four, collapsible side panels 110. Each side panel 110 includes a flexible frame member 112, which has a folded and unfolded configuration, and a flexible panel material 114 coupled, directly or indirectly, to the frame member 112. Each side panel 110 in its unfolded configuration has a top portion 111 and a bottom portion 113, the top portion 111 being preferably narrower than the bottom portion 113. The flexible panel material 114 may be directly coupled to the frame member 112 by cutting the panel material 114 in a desired shape slightly larger than the frame member 112 and by folding the panel material 114 around the frame member 112 and securing it thereto, either by fastening the panel material 114 to itself by way of adhesive, sewing or the like, or by fastening the panel material 114 to the frame member 112 by way of adhesive, for example. The flexible panel material 114 may be indirectly coupled to the frame member 112 by way of other structures, such as a support pocket 116 formed from a pocket material, which may or may not be the same composition as the flexible panel material 114.

Additionally, one or more side panels 110 of the second embodiment 200 may be provided with a closeable access portal 201, allowing selective access through a side panel 110. The portal 201 may be covered by a portal flap 202 which is preferably hingedly coupled near the top portion 111 of the side panel 110. The portal flap 202 may be partially releasably fastened to the panel material 114, such as by way of a zipper 203. When desirable, the portal 201 may be exposed and the portal flap 202 may be held out of the way by a flap retainer 204, which may include a ring 205 coupled to the panel 110 and a cooperating strap 206, which may include a fastening means such as hook-and-loop fasteners.

Other components may be provided as a part of, or fastened to, one or more of the side panels 110. For instance, a reinforcement flap 208 may be provided proximate the bottom portion 113 of one or more panels 110. If provided, the reinforcement flap 208 may include a plurality of stake loops 222. Through the stake loops 222, a stake 124 may be inserted, thereby cooperating with the ground or other support surface to maintain the plant shelter 100 in a desired location. In addition to a reinforcement flap 208, a top panel 130 may be provided, coupled to at least one but preferably multiple side panels 110 proximate the top portion 111 thereof. The top panel 130 is formed from a top panel material that may be the same as or different than the side panel material 114. In this embodiment, the top panel 130 is made of a flexible, polyethylene sheet material.

While the flexible side panel material 114 may be any material suitable for providing desired plant coverage, at least a portion of the panel material 114 preferably comprises a nonopaque, flexible, fluid impervious material, such as a clear polyethylene sheet material. Use of such material may provide a desired greenhouse effect that may be advantageous to starting or maintaining plant growth. Alternatively, if it is desirable to only shade a plant, a fluid pervious material that provides desired shade could also be used. The side panels 110 are generally arranged in a ring configuration so that a given panel 110a is coupled, directly or indirectly, to two other panels 110b,110d.

Like the first embodiment in FIG. 2, to use this second embodiment 200 of a collapsible plant shelter according to the present invention, the shelter 200 is simply placed, in its uncollapsed configuration, over a plant and preferably staked to the ground or supported by a different existing support structure. When placed on relatively level ground, the side panels preferably intersect the supporting surface at an angle, which, though a variety of angles would suffice, is preferably obtuse, as shown in FIG. 2 with reference to the first embodiment 100.

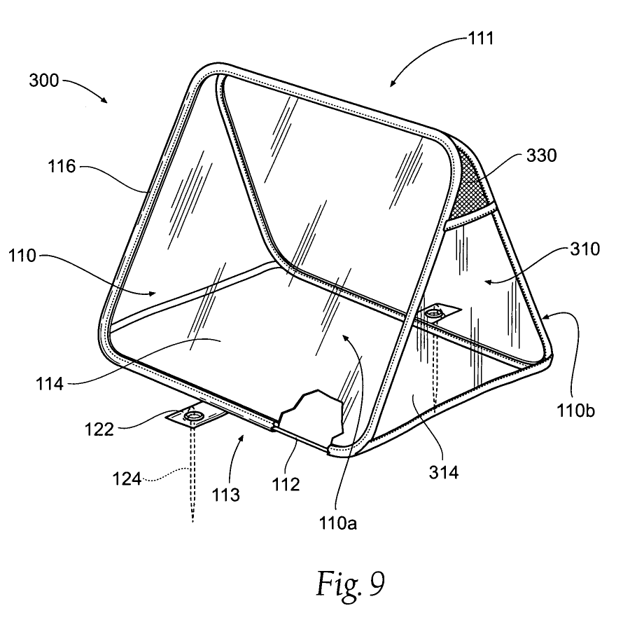

FIG. 9 provides a third embodiment 300 of a plant shelter according to the present invention is shown. Unlike the first embodiment 100 or the second embodiment 200, this embodiment 300 comprises only two collapsible side panels 110. Each side panel 110 includes a flexible frame member 112, which has a folded and unfolded configuration, and a flexible panel material 114 coupled, directly or indirectly, to the frame member 112. Each side panel 110 in its unfolded configuration has a top portion 111 and a bottom portion 113. The flexible panel material 114 may be directly coupled to the frame member 112 by cutting the panel material 114 in a desired shape slightly larger than the frame member 112 and by folding the panel material 114 around the frame member 112 and securing it thereto, either by fastening the panel material 114 to itself by way of adhesive, sewing or the like, or by fastening the panel material 114 to the frame member 112 by way of adhesive, for example. The flexible panel material 114 may be indirectly coupled to the frame member 112 by way of other structures, such as a support pocket 116 formed from a pocket material, which may or may not be the same composition as the panel flexible panel material 114.

The side panels 110 are generally arranged in a V configuration so that the top portion 111 of a first panel 110a is coupled, directly or indirectly, to the top portion. 111 of a second panel 110b. Further, a side gusset panel 310 is coupled to the side panels 110, preferably on each end. The gusset panel 310 comprises a flexible gusset material 314, and may also include a top vent 330, which is preferably formed from a mesh material. While the flexible side panel material 114 and gusset material 314 may be any material suitable for providing desired plant coverage, at least a portion of the material 114,314 preferably comprises a nonopaque, flexible, fluid impervious material, such as a clear polyethylene sheet material. Use of such material may provide a desired greenhouse effect that may be advantageous to starting or maintaining plant growth. Alternatively, if it is desirable to only shade a plant, a fluid pervious material that provides desired shade could also be used.

To use this third embodiment 300 of a collapsible plant shelter according to the present invention, the shelter 300 may be expanded by parting the bottom portions 113 of the side panels 110 to the extent desired and then placed, in its expanded configuration, over a plant and preferably staked to the ground or supported by a different existing support structure.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

We claim:

1. A collapsible plant shelter comprising:
at least three side panels, each side panel comprising a flexible panel material coupled to a frame member having a folded and an unfolded configuration, said flexible panel material assuming the configuration of its associated frame member in its unfolded configuration, each side panel having a top portion, a bottom portion, an inside surface and an outside surface;
wherein each side panel is coupled to at least a first adjacent side panel and a second adjacent side panel; and
wherein at least part of said flexible panel material is fluid impervious.

2. A collapsible plant shelter according to claim 1, wherein each said flexible panel material is directly coupled to a frame member.

3. A collapsible plant shelter according to claim 1, further comprising a stake loop coupled to said bottom portion of at least one of said side panels.

4. A collapsible plant shelter according to claim 1, further comprising a reinforcement gusset coupled to said bottom portion of two adjacent side panels.

5. A collapsible plant shelter according to claim 1, further comprising a flexible top panel coupled to said top portion of a plurality of said side panels.

6. A collapsible plant shelter according to claim 5, said flexible top panel comprising a flexible mesh material.

7. A collapsible plant shelter according to claim 1, said flexible panel material comprising polyethylene sheet material.

8. A collapsible plant shelter according to claim 7, said flexible panel material comprising a substantially transparent polyethylene sheet material.

9. A collapsible plant shelter according to claim 1, said top portion being narrower than said bottom portion.

10. A collapsible plant shelter according to claim 1, wherein, when said shelter is placed upon a desired support surface, an angle measured between said outside surface of said panel material and said support surface is obtuse.

11. A collapsible plant shelter comprising:
at least three side panels, each side panel comprising a flexible panel material coupled to a frame member having a folded and an unfolded configuration, said flexible panel material assuming the configuration of its associated frame member in its unfolded configuration, each side panel having a top portion, a bottom portion, an inside surface and an outside surface;
wherein each side panel is coupled to at least a first adjacent side panel and a second adjacent side panel; and
wherein at least one of said side panels includes a selectively closeable access portal.

12. A collapsible plant shelter according to claim 11, wherein at least part of said flexible panel material is fluid impervious.

13. A collapsible plant shelter according to claim 12, said flexible panel material comprising, polyethylene sheet material.

14. A collapsible plant shelter according to claim 13, said flexible panel material comprising a substantially transparent polyethylene sheet material.

15. A collapsible plant shelter according to claim 11 further comprising:
a portal flap hingedly coupled proximate said top portion of each of said side panels having a selectively closeable access portal,
said portal flap being at least partially selectively releasable from said flexible panel material.

16. A collapsible plant shelter according to claim 15, wherein said portal flap is at least partially selectively releasable from said flexible panel material by way of a zipper.

17. A collapsible plant shelter according to claim 15, said shelter further comprising a flap retainer coupled proximate said top portion of each of said side panels having a selectively closeable access portal.

18. A collapsible plant shelter according to claim 11, said shelter comprising four of said side panels, wherein each of two of said side panels includes a selectively closeable access portal.

19. A collapsible plant shelter according to claim 18, said two side panels including a selectively closeable access portal being diametrically opposed side panels of said shelter.

20. A collapsible plant shelter comprising:
a first side panel and a second side panel, each side panel comprising a flexible panel material coupled to a frame member having a folded and an unfolded configuration, said flexible panel material assuming the configuration of its associated frame member in its unfolded configuration, each side panel having a top portion and a bottom portion; and
a first gusset panel comprising a flexible gusset material, said gusset panel being coupled to an end of each of said side panels,
wherein said top portion of said first side panel is coupled to said top portion of said second side panel, and
wherein at least a portion of said flexible panel material and at least a portion of said flexible gusset material is fluid impervious.

21. A collapsible plant shelter according to claim 20, wherein each said flexible panel material is directly coupled to a frame member.

22. A collapsible plant shelter according to claim 20, further comprising a stake loop coupled to said bottom portion of at least one of said side panels.

23. A collapsible plant shelter according to claim 20, said flexible panel material comprising polyethylene sheet material.

24. A collapsible plant shelter according to claim 23, said flexible panel material comprising a substantially transparent polyethylene sheet material.
